(19) United States
(12) Patent Application Publication
(10) Pub. No.: US 2013/0061048 A1
(43) Pub. Date: Mar. 7, 2013

(54) CONTENT DELIVERY SYSTEM, DELIVERY SERVER, AND USER TERMINAL

(71) Applicants: Hiroshi Suu, Chigasaki-shi (JP); Akira Miura, Sagamihara-shi (JP); Akihiro Kasahara, Sanbu-gun (JP); Shinichi Matsukawa, Suginami-ku (JP)

(72) Inventors: Hiroshi Suu, Chigasaki-shi (JP); Akira Miura, Sagamihara-shi (JP); Akihiro Kasahara, Sanbu-gun (JP); Shinichi Matsukawa, Suginami-ku (JP)

(21) Appl. No.: 13/583,956

(22) PCT Filed: Mar. 11, 2010
(86) PCT No.: PCT/JP2010/054149

§ 371 Date: Nov. 21, 2012

(51) Int. Cl. G06F 21/24

(52) U.S. Cl. 713/165

(57) ABSTRACT

Provided are a content delivery system, a delivery server and a user terminal whereby the load of a party who transmits content data cau be reduced. A delivery server (10) transmits, to a user terminal (20), encrypted content data Eno (Kci:Ci), encrypted content key data Enc (Kul:Kci), and encrypted control data Eno (Kui:Pi). Control data Pi includes: reproduction designation data PLI that designates a reproduction order of a plurality of pieces of content data Ci and that also designates a reproduction section of the content data Ci; and reproduction condition data URi that specifies a condition for permitting the reproduction of particular content data Ci and CMi in accordance with a predetermined reproduction procedure.

### TECHNICAL FIELD

The present invention relates to: a content delivery system for delivering content data according to a request from a user terminal maintained by a user; a delivery server employed in that system; and the user terminal.

### BACKGROUND ART

In recent years, data is received whereby content of digital information such as music or visual images is listened to or viewed, not only by the likes of terrestrial television, AM, and FM broadcasts, but also by a communication terminal connected to a communication network such as the internet. This digital information, that is, content data, may be easily copied, hence measures are taken to encrypt the content data to be delivered. For example, in Patent Document 1, encryption of content data is performed using a double key encryption system.

Moreover, in order to obtain an advertising fee, a party who transmits content data transmits composite content data combining a main story (movie, drama, and so on) and an advertisement (commercial). On the other hand, in order to fully enjoy a content of the content data, a listener or viewer of the content data generally desires to skip the advertisement and continuously listen to or view only the main story. Thus, in order to secure an advantage of the transmitting party side, the composite content data is controlled by reproduction control data to make it impossible to listen or view while skipping the advertisements.

However, in order to execute reproduction control in the above-described manner, it is required to re-edit the content data and reproduction control data over its entirety on an encrypted content data basis, which places a heavy burden on the party who transmits the content data.

### PRIOR ART DOCUMENT

### Patent Document

[Patent Document 1] JP 2006-020154 A

### DISCLOSURE OF INVENTION

### Problem to be Solved by the Invention

The present invention provides a content delivery system, a delivery server, and a user terminal whereby a burden on a party who transmits content data can be reduced.

### Means for Solving the Problem

A content delivery system according to an aspect of the present invention comprises a user terminal maintained by a user, and a delivery server for delivering content data to the user terminal, the delivery server comprising: a transmitting unit configured to transmit to the user terminal encrypted content data encrypted by content key data that differs on a content data basis, transmit to the user terminal encrypted content key data that is the content key data encrypted by user key data that differs on a user basis, and transmit to the user terminal encrypted control data that is control data for controlling a reproduction operation of the content data encrypted by the user key data, the control data including: reproduction designation data that designates a reproduction order of the content data to be reproduced; and reproduction condition data that specifies a condition for permitting reproduction of the content data, and the user terminal comprising: a decoding unit configured to generate the content key data based on the encrypted content key data and the user key data, generate the control data based on the encrypted control data and the user key data, and generate the content data based on the content key data and the encrypted content data; and a reproducing unit configured to reproduce the content data according to the reproduction order designated by the reproduction designation data and the condition specified by the reproduction condition data.

A content delivery system according to an aspect of the present invention includes a user terminal maintained by a user, and a delivery server for delivering content data to the user terminal, the delivery server comprising: a first hash data generating unit configured to perform hash processing of control data controlling a reproduction operation of the content data and thereby generate first hash data; an encrypting unit configured to encrypt the first hash data by user key data that differs on a user basis and thereby generate signature data; and a transmitting unit configured to transmit to the user terminal encrypted content data encrypted by content key data that differs on a content data basis, transmit to the user terminal encrypted content key data that is the content key data encrypted by the user key data that differs on a user basis, and transmit to the user terminal the control data and the signature data, the control data including: reproduction designation data that designates a reproduction order of the content data to be reproduced; and reproduction condition data that specifies a condition for permitting reproduction of the content data, and the user terminal comprising: a decoding unit configured to generate the content key data based on the encrypted content key data and the user key data, generate the content data based on the content key data and the encrypted content data, and generate the first hash data based on the user key data and the signature data; a second hash data generating unit configured to perform hash processing of the control data and thereby generate second hash data; a hash data cross-checking unit for cross-checking the first hash data and the second hash data; and a reproducing unit configured to, when it is judged by the hash data cross-checking unit that the first hash data and the second hash data match, reproduce the content data according to the reproduction order designated by the reproduction designation data and the condition specified by the reproduction condition data.

A delivery server according to an aspect of the present invention is for delivering content data to a user terminal and comprises: a transmitting unit configured to transmit to the user terminal encrypted content data encrypted by content key data that differs on a content data basis, transmit to the user terminal encrypted content key data that is the content key data encrypted by user key data that differs on a user basis, and transmit to the user terminal encrypted control data that is control data for controlling a reproduction operation of the content data encrypted by the user key data, the control data including: reproduction designation data that designates a reproduction order of the content data to be reproduced; and reproduction condition data that specifies a condition for permitting reproduction of the content data.

A user terminal according to an aspect of the present invention comprises: a decoding unit configured to generate content key data that differs on a content data basis based on user key data and encrypted content key data that differ on a user basis, generate control data for controlling a reproduction operation of the content data based on encrypted control data and the user key data, and generate the content data based on the content key data and the encrypted content data; and a reproducing unit for reproducing the content data based on the control data, the control data including: reproduction designation data that designates a reproduction order of the content data to be reproduced; and reproduction condition data that specifies a condition for permitting reproduction of the content data, and the reproducing unit reproducing the content data according to the reproduction order designated by the reproduction designation data and the condition specified by the reproduction condition data.

### Effect of the Invention

The present invention allows provision of a content delivery system, a delivery server, and a user terminal whereby a burden on a party who transmits content data can be reduced.

### BRIEF DESCRIPTION OF DRAWINGS

FIG. 1 is a schematic view of a content delivery system according to a first embodiment.

FIG. 2 is a view showing details of control data Pi.

FIG. 3 is a block diagram showing a specific configuration of a decoding unit 24c according to the first embodiment.

FIG. 4 is a view showing one example of a screen for displaying in a display unit 20c according to the first embodiment.

FIG. 5 is a flowchart showing schematically operation of the content delivery system according to the first embodiment.

FIG. 6A is a flowchart showing specific operation of the decoding unit 24c according to the first embodiment.

FIG. 6B is a flowchart showing specific operation of the decoding unit 24c according to the first embodiment.

FIG. 7 is a schematic view of a content delivery system according to a second embodiment.

FIG. 8 is a block diagram showing a specific configuration of a decoding unit 24ca according to the second embodiment.

FIG. 9 is a flowchart showing schematically operation of the content delivery system according to the second embodiment.

FIG. 10 is a flowchart showing specific operation of the decoding unit 24c according to the second embodiment.

FIG. 11 is a view showing reproduction designation data PL according to a third embodiment.

FIG. 12 is a view showing a method of using reproduction condition data URi according to a fourth embodiment.

### BEST MODE FOR CARRYING OUT THE INVENTION

### First Embodiment

[Configuration]

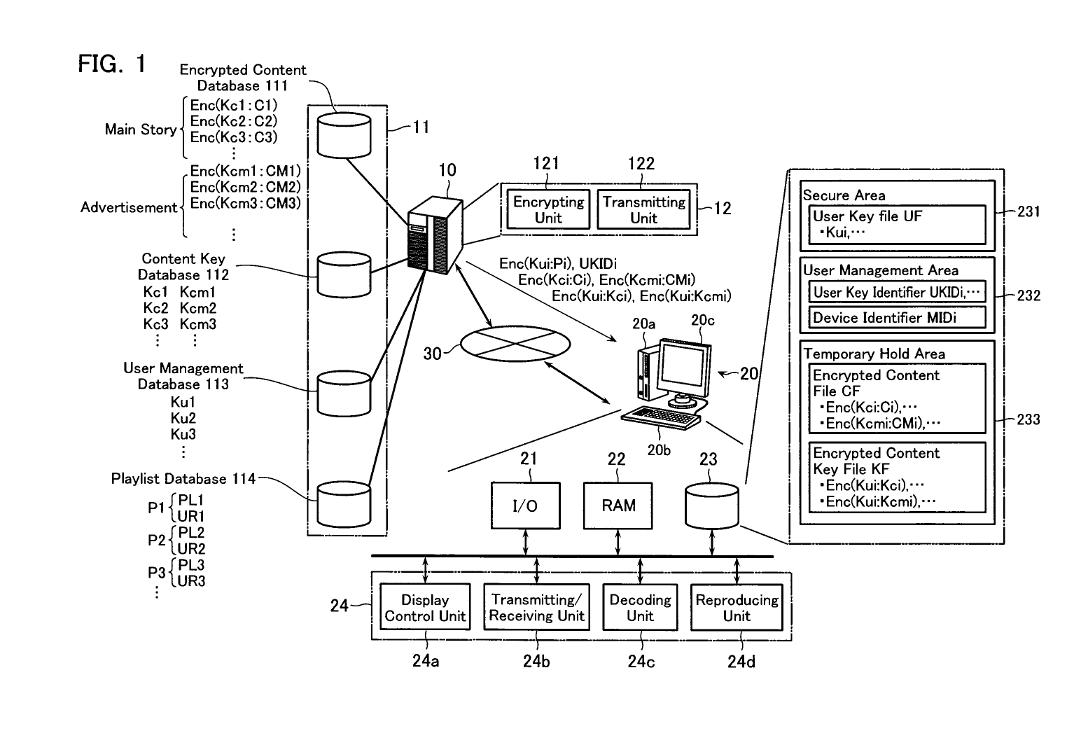

First, a configuration of a content delivery system according to a first embodiment is described with reference to FIG. 1. As shown in FIG. 1, the content delivery system according to the first embodiment is configured by a delivery server 10 for delivering content data and a user terminal 20 managed by a user. These delivery server 10 and user terminal 20 are connected via a communication network 30 such as the Internet.

The delivery server 10 comprises a memory unit 11 such as an HDD (Hard Disc Drive) and a control unit 12 such as a CPU (Central Processing Unit). Note that a function of the control unit 12 is implemented by various programs read out from the memory unit 11.

The memory unit 11 comprises an encrypted content database 111, a content key database 112, a user management database 113, and a playlist database 114. In addition, the memory unit 11 stores the previously mentioned programs.

The encrypted content database 111 stores encrypted content data Enc(Kci:Ci), Enc(Kcmi:CMi) (where i is a natural number). In the present specification, the notation Enc(A:B) herein signifies data B encrypted by data A. Hence, the encrypted content data Enc(Kci:Ci), Enc(Kcmi:CMi) are plaintext content data Ci, CMi encrypted by content key data Kci, Kcmi. The content data Ci indicates content data of a main story (drama, movie, and so on). The content data CMi indicates content data of an advertisement (CM=commercial). Note that content data Ci, CMi is configured capable of being reproduced according to a condition specified by reproduction condition data URi to be described later.

The content key database 112 stores the content key data Kci, Kcmi. The content key data Kci decodes the encrypted content data Enc(Kci:Ci). The content key data Kcmi decodes the encrypted content data Enc(Kcmi:CMi).

The user management database 113 stores user key data Kui. The user key data Kui differs on a user basis. However, it is also possible that one user has a plurality of user key data. For example, one user may employ different user key data for each of different kinds of content data.

The playlist database 114 includes control data Pi. The control data Pi is data for controlling a reproduction operation of the content data Ci, CMi. The control data Pi includes reproduction designation data PLi (PLPlay List) and reproduction condition data URi (URUsage Rule). The reproduction designation data PLi designates a reproduction order of a plurality of content data Ci, CMi to be reproduced. The reproduction condition data URi specifies a condition for permitting reproduction of the content data Ci, CMi.

The control unit 12 includes an encrypting unit 121 and a transmitting unit 122. The encrypting unit 121 encrypts the content key data Kci, Kcmi by means of the user key data Kui to generate encrypted content key data Enc(Kui:Kci), Enc(Kui:Kcmi). In addition, the encrypting unit 121 encrypts the control data Pi by means of the user key data Kui to generate encrypted control data Enc(Kui:Pi).

The transmitting unit 122 transmits to the user terminal 20 the encrypted content data Enc(Kci:Ci), Enc(Kcmi:CMi), the encrypted content key data Enc(Kui:Kci), Enc(Kui:Kcmi), and the encrypted control data Enc(Kui:Pi). In addition, to enable the encrypted control data Enc(Kui:Pi) to be decoded by specific user key data Kui, the transmitting unit 122 transmits to the user terminal 20 user key identifier UKIDi along with the encrypted control data Enc(Kui:Pi).

The user terminal 20 includes a user terminal main body 20a, an input unit (keyboard, mouse, and so on) 20b, and a display unit 20c. The user terminal main body 20a comprises an I/O 21, a RAM 22, a memory unit 23 such as an HDD, and a control unit 24 such as a CPU. Note that a function of the control unit 24 is implemented by various programs read out from the memory unit 23.

The memory unit 23 includes a secure area 231, a user management area 232, and a temporary hold area 233. In addition, the memory unit 23 stores the previously mentioned various programs.

The secure area 231 retains securely a user key file UF. The user key file UF includes a plurality of user key data Kui. The user management area 232 retains a user-specific user key identifier UKIDi, and a device-specific device identifier MIDi. The temporary hold area 233 retains temporarily an encrypted content file CF and an encrypted content key file KF. The encrypted content file CF provides a storage area for storing a plurality of the encrypted content data Enc(Kci:Ci), Enc(Kcmi:CMi) transmitted from the delivery server 10. The encrypted content key file KF provides a storage area for storing a plurality of the encrypted content key data Enc(Kui:Kci), Enc(Kui:Kcmi) transmitted from the delivery server 10.

The control unit 24 includes a display control unit 24a, a transmitting/receiving unit 24b, a decoding unit 24c, and a reproducing unit 24d. The display control unit 24a displays reproducibly-rendered content data Ci, CMi in the display unit 20c. The transmitting/receiving unit 24b transmits to the delivery server 10 a command requesting the content data Ci. In addition, the transmitting/receiving unit 24b receives the encrypted content data Enc(Kci:Ci), Enc(Kcmi:CMi), the encrypted content key data Enc(Kui:Kci), Enc(Kui:Kcmi), the encrypted control data Enc(Kui:Pi), and the user key identifier UKIDi.

The decoding unit 24c decodes the encrypted content key data Enc(Kui:Kci), Enc(Kui:Kcmi) by means of the user key data Kui and thereby generates the content key data Kci, Kcmi. In addition, the decoding unit 24c decodes the encrypted control data Enc(Kui:Pi) by means of the user key data Kui and thereby generates the control data Pi. Moreover, the decoding unit 24c decodes the encrypted content data Enc(Kci:Ci), Enc(Kcmi:CMi) by means of the content key data Kci, Kcmi and thereby generates the content data Ci, CMi.

The reproducing unit 24d reproduces the content data Ci, CMi according to the reproduction order designated by the reproduction designation data PLi and the condition specified by the reproduction condition data URi.

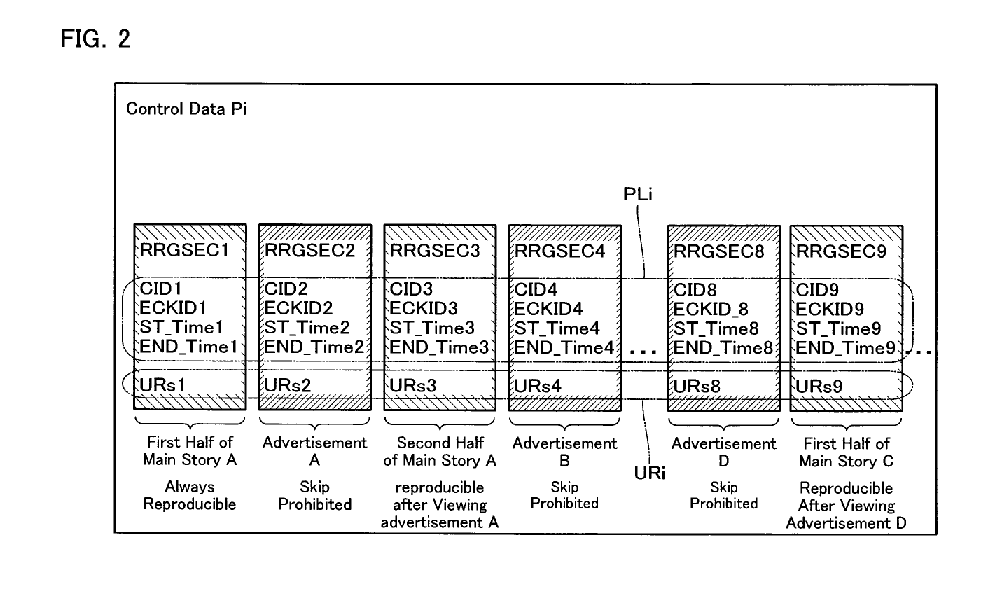

Next, a specific configuration of the control data Pi is described with reference to FIG. 2. As mentioned above, the control data Pi includes the reproduction designation data PLi and the reproduction condition data URi. As shown in FIG. 2, the reproduction designation data PLi and the reproduction condition data URi herein are configured by section data PRGSEC1, 2, 3, 4, . . . , 8, 9, . . . arranged in the reproduction order. These section data PRGSECi each specify the content data Ci, CMi to be reproduced at a specific time and a condition for permitting reproduction of that content data Ci, CMi. For example, these section data PRGSECi specify the kind and reproduction order of the content data Ci, CMi in such a manner as first half of main story A, advertisement A, second half of main story A, advertisement B, . . . , advertisement D, first half of main story C, . . . . For example, the first half of main story A is set with a condition of being always reproducible, and the advertisements A, B, and D are set with conditions of for example skip prohibit, fast-forward prohibit, or the like. In addition, the second half of main story A is for example set with a condition of being reproducible after viewing of advertisement A, and the first half of main story C is set with a condition of being reproducible after viewing of advertisement D.

As shown in FIG. 2, the section data PRGSECi each includes a content identifier CIDi, an encrypted content key identifier ECKIDi, time data (start time data ST_Time(i), end time data END_Time(i)), and section reproduction condition data URsi.

The content identifier CIDi specifies the content data Ci, CMi, and the content key data Kci, Kcmi and encrypted content data Enc(Kci:Ci), Enc(Kcmi:CMi) corresponding to those content data Ci, CMi. The encrypted content key identifier ECKIDi specifies the encrypted content key data Enc(Kui:Kci), Enc(Kui:Kcmi). The start time data ST_Time(i) specifies a reproduction start time of specified content data Ci, CMi, and the end time data END_Time(i) specifies a reproduction end time of specified content data Ci, CMi. Section reproduction condition data URsi specifies a condition for permitting reproduction in each content data Ci, CMi.

That is, the content identifier CIDi, the encrypted content key identifier ECKIDi, the start time data ST_Time(i), and the end time data END_Time(i) included in a plurality of section data PRGSECi configure the reproduction designation data PLi. In addition, the section reproduction condition data URsi included in a plurality of section data PRGSECi configure the reproduction condition data URi.

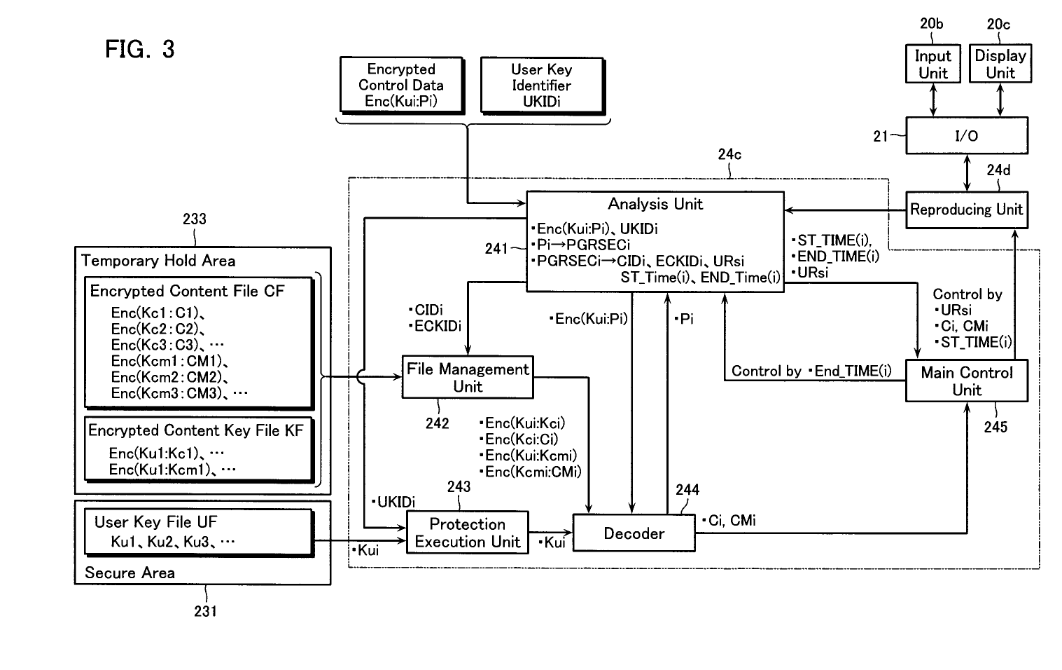

Next, a specific configuration of the decoding unit 24c and the reproducing unit 24d in the user terminal 20 are described with reference to FIG. 3.

As shown in FIG. 3, the decoding unit 24c includes an analysis unit 241, a file management unit 242, a protection execution unit 243, a decoder 244, and a main control unit 245.

The analysis unit 241 extracts the encrypted control data Enc(Kui:Pi) and the user key identifier UKIDi from the data received by the transmitting/receiving unit 24b. In addition, the analysis unit 241 analyzes the control data Pi decoded by the decoder 244 and thereby extracts each of the section data PRGSECi. Furthermore, the analysis unit 241 analyzes each of the section data PRGSECi and thereby extracts from one section data PRGSECi the content identifier CIDi, the encrypted content key identifier ECKIDi, the start time data ST_Time(i), the end time data END_Time(i), and the section reproduction condition data URsi. The analysis unit 241 inputs the user key identifier UKIDi into the protection execution unit 243. The analysis unit 241 inputs the content identifier CIDi and the encrypted content key identifier ECKIDi into the file management unit 242. The analysis unit 241 inputs the start time data ST_Time(i), the end time data END_Time(i), and the section reproduction condition data URsi into the main control unit 245.

The file management unit 242 reads out specific encrypted content data Enc(Kci:Ci), Enc(Kcmi:CMi) from the encrypted content file CF based on the content identifier CIDi inputted from the analysis unit 241. In addition, the file management unit 242 reads out specific encrypted content key data Enc(Kui:Kci), Enc(Kui:Kcmi) from the encrypted content key file KF based on the encrypted content key identifier ECKIDi inputted from the analysis unit 241. Furthermore, the file management unit 242 inputs the encrypted content data Enc(Kci:Ci), Enc(Kcmi:CMi) and the encrypted content key data Enc(Kui:Kci), Enc(Kui:Kcmi) read out from the encrypted content file CF and the encrypted content key file KF into the decoder 244.

The protection execution unit 243 reads out specific user key data Kui from the user key file UF based on the user key identifier UKIDi inputted from the analysis unit 241, and sends this specific user key data Kui to the decoder 244.

The decoder 244 decodes the encrypted content key data Enc(Kui:Kci), Enc(Kui:Kcmi) and the encrypted control data Enc(Kui:Pi) by means of the user key data Kui obtained from the protection execution unit 243, and thereby generates the content key data Kci, Kcmi and the control data Pi. In addition, the decoder 244 decodes the encrypted content data Enc(Kci:Ci), Enc(Kcmi:CMi) by means of the content key data Kci, Kcmi, and thereby generates the content data Ci, CMi. Furthermore, the decoder 244 inputs the decoded control data Pi into the analysis unit 241 and inputs the content data Ci, CMi into the main control unit 245.

The main control unit 245 inputs the content data Ci and the section reproduction condition data URsi into the reproducing unit 24d, at the start time ST_Time(i), based on the section reproduction condition data URsi. The main control unit 245 controls the analysis unit 241 to analyze the next section data PRGSECi by a certain time, based on the end time End_Time(i).

The reproducing unit 24d receives a control signal from the input unit 20b via the I/O 21. The control signal is a signal instructing for example a reproduction instruction, fast forward, rewind, forward skip, back skip, and so on, of the content data, and the reproducing unit 24d controls reproduction of the content data Ci, CMi according to these control signals. The reproducing unit 24d invalidates part of the control signals according to the section reproduction condition data URsi, and thereby displays only an operable operation in the display unit 20c.

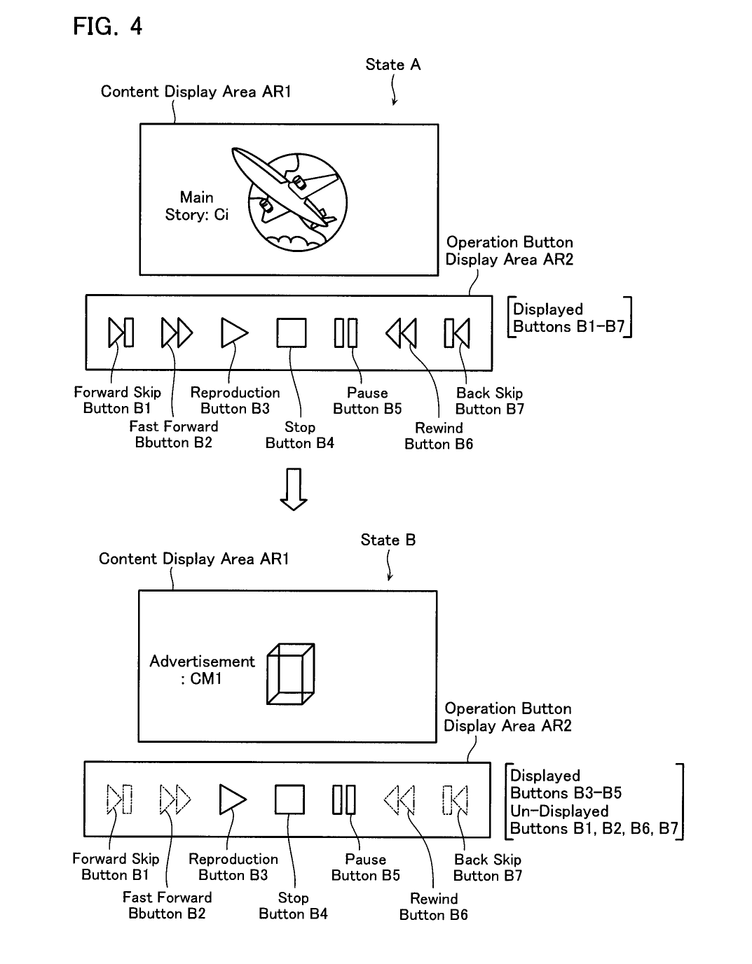

For example, as shown in FIG. 4, the reproducing unit 24d displays a content display area AR1 and an operation button display area AR2 in the display unit 20c, based on the reproduction condition data URi. The content display area AR1 is an area for displaying the content data Ci, CMi. The operation button display area AR2 is an area for displaying various operation buttons B1-B7 operable by the user.

For example, when the main story-related content data Ci is displayed in the content display area AR1 (state A in FIG. 4), all of the operation buttons B1-B7 including back skip, forward skip, and so on, are displayed, according to the section reproduction condition data URsi. On the other hand, when the advertisement-related content data CMi is displayed in the content display area AR1 (state B in FIG. 4), the operation buttons B1, B2, B6, and B7 for rewind, fast forward, and so on, are rendered un-displayed according to the section reproduction condition data URsi, whereby operations other than reproduction, stop, and pause are execution-prohibited (control signals are invalidated).

[Operation]

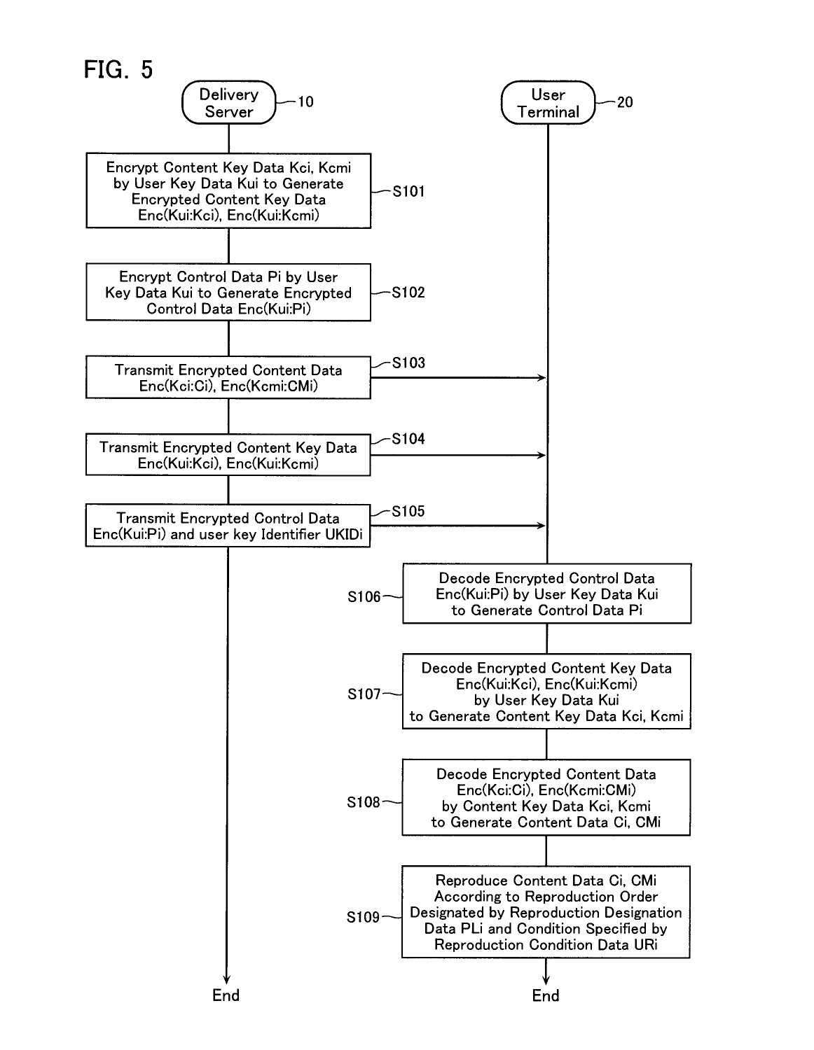

Next, an overview of operation of the content delivery system according to the first embodiment is described with reference to FIG. 5. First, the delivery server 10 encrypts the content key data Kci, Kcmi in the encrypting unit 121 by means of the user key data Kui, and thereby generates the encrypted content key data Enc(Kui:Kci), Enc(Kui:Kcmi) (step S101). Next, the delivery server 10 encrypts the control data Pi in the encrypting unit 121 by means of the user key data Kui, and thereby generates the encrypted control data Enc(Kui:Pi) (step S102).

Then, the delivery server 10 transmits the encrypted content data Enc(Kci:Ci), Enc(Kcmi:CMi) in the transmitting unit 122 to the user terminal 20 (step S103). The user terminal 20 stores the received encrypted content data Enc(Kci:Ci), Enc(Kcmi:CMi) in the encrypted content file CF provided in the temporary hold area 233.

Next, the delivery server 10 transmits the encrypted content key data Enc(Kui:Kci), Enc(Kui:Kcmi) in the transmitting unit 122 to the user terminal 20 (step S104). The encrypted content key data Enc(Kui:Kci), Enc(Kui:Kcmi) is stored in the encrypted content key file KF in the temporary hold area 233.

Then, the delivery server 10 transmits the encrypted control data Enc(Kui:Pi) and the user key identifier UKIDi in the transmitting unit 122 to the user terminal 20 (step S105).

Next, the user terminal 20, after reading the corresponding user key Kui from the user key file UF based on the user key identifier UKIDi, decodes the received encrypted control data Enc(Kui:Pi) in the decoding unit 24c by means of the user key data Kui, and thereby generates the control data Pi (step S106). Then, the user terminal 20 decodes the encrypted content key data Enc(Kui:Kci), Enc(Kui:Kcmi) in the decoding unit 24c by means of the user key data Kui, and thereby generates the content key data Kci, Kcmi (step S107).

Next, the user terminal 20 decodes the encrypted content data Enc(Kci:Ci), Enc(Kcmi:CMi) in the decoding unit 24 by means of the content key data Kci, Kcmi, and thereby generates the content data Ci, CMi (step S108).

Then, the user terminal 20 reproduces the content data Ci according to the reproduction order designated by the reproduction designation data PLi and the condition specified by the reproduction condition data URi included in the control data Pi (step S109). That concludes operation of the content delivery system according to the first embodiment.

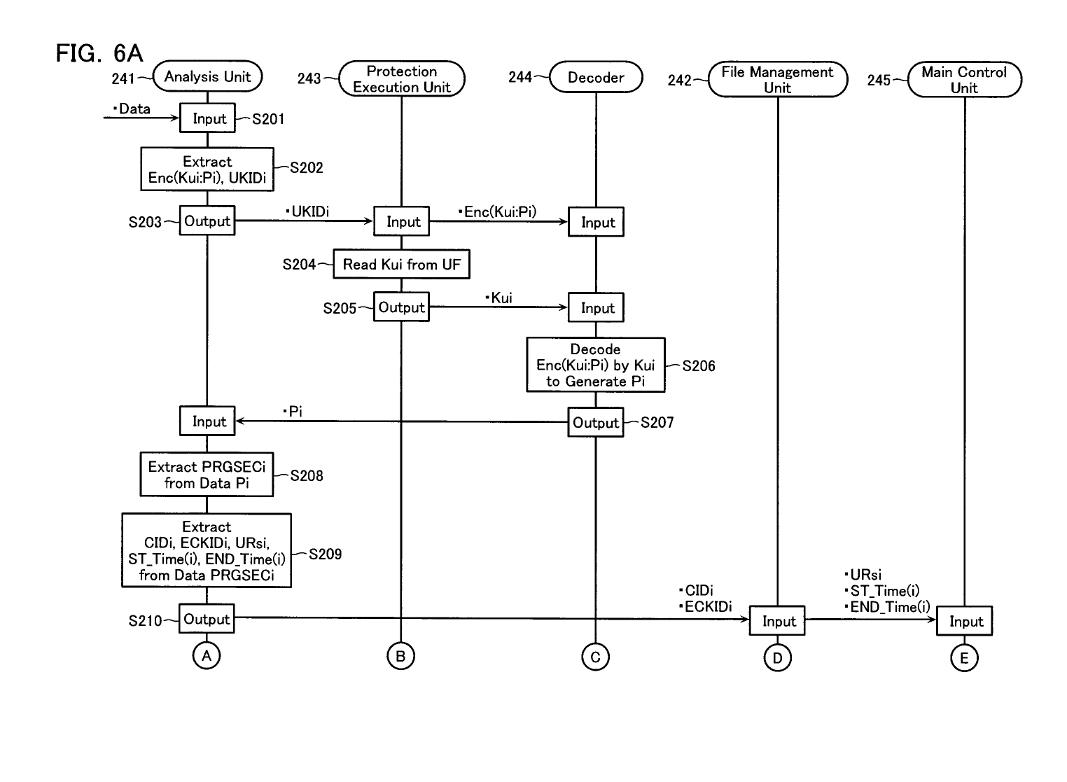

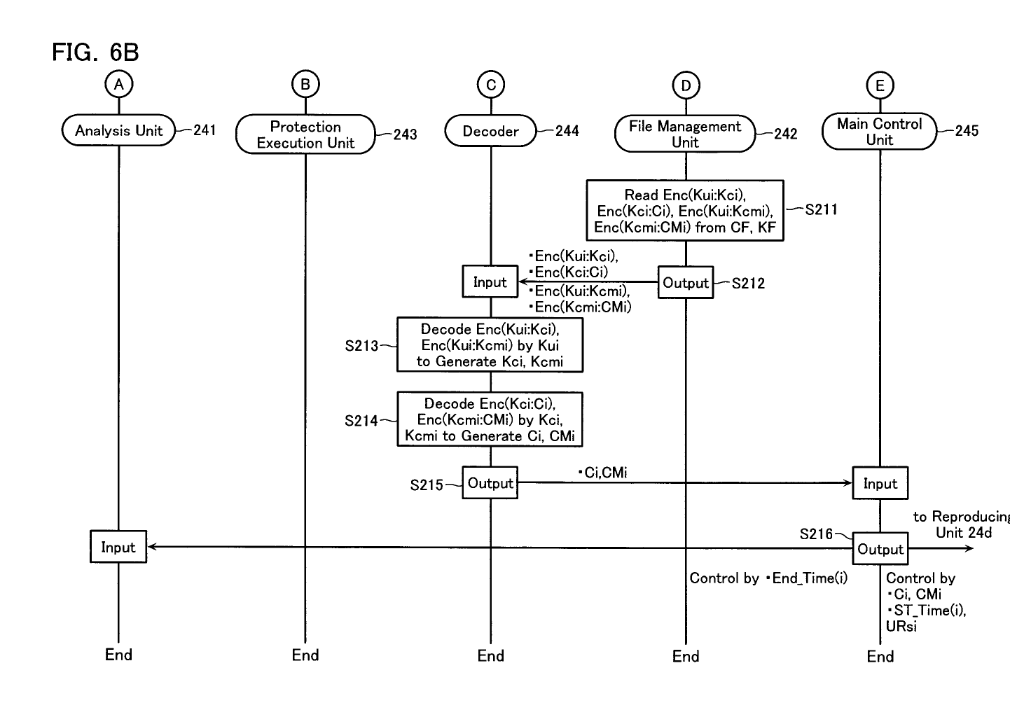

Next, specific operation of the decoding unit 24c (analysis unit 241, file management unit 242, protection execution unit 243, decoder 244, and main control unit 245) in the user terminal 20 is described with reference to FIGS. 6A and 6B.

As shown in FIG. 6A, the analysis unit 241 receives data from the transmitting/receiving unit 24b (step S201), and extracts from that data the user key identifier UKIDi and the encrypted control data Enc(Kui:Pi) (step S202). Then, the analysis unit 241 inputs the user key identifier UKIDi into the protection execution unit 243, and meanwhile inputs the encrypted control data Enc(Kui:Pi) into the decoder 244.

Next, the protection execution unit 243 reads specific user key data Kui from the user key file UF based on the user key identifier UKIDi (step S204). Next, the protection execution unit 243 inputs the read user key data Kui into the decoder 244 (step S205).

Then, the decoder 244 decodes the encrypted control data Enc(Kui:Pi) by means of the user key data Kui, and thereby generates the control data Pi (step S206). Next, the decoder 244 inputs the control data Pi into the analysis unit 241 (step S207).

Next, the analysis unit 241 extracts the section data PRGSECi from the control data Pi (step S208). Then, the analysis unit 241 extracts from the section data PRGSECi the content identifier CIDi, the encrypted content key identifier ECKIDi, the time data (start time data ST_Time(i), end time data END_Time(i)), and the section reproduction condition data URsi (step S209). Next, the analysis unit 241 inputs the content identifier CIDi and the encrypted content key identifier ECKIDi into the file management unit 242, and meanwhile inputs the start time data ST_Time(i), the end time data END_Time(i), and the section reproduction condition data URsi into the main control unit 245 (step S210).

Then, as shown in FIG. 6B, the file management unit 242 reads specific encrypted content data Enc(Kci:Ci), Enc(Kcmi:CMi) from the encrypted content file CF based on the content identifier CIDi (step S211). In addition, the file management unit 242 reads specific encrypted content key data Enc(Kui:Kci), Enc(Kui:Kcmi) from the encrypted content key file KF based on the encrypted content key identifier ECKIDi (step S211). Next, the file management unit 242 inputs the encrypted content data Enc(Kci:Ci), Enc(Kcmi:CMi) and the encrypted content key data Enc(Kui:Kci), Enc(Kui:Kcmi) into the decoder 244 (step S212).

Then, the decoder 244 decodes the encrypted content key data Enc(Kui:Kci), Enc(Kui:Kcmi) by means of the user key data Kui, and thereby generates the content key data Kci, Kcmi (step S213). Next, the decoder 244 decodes the encrypted content data Enc(Kci:Ci), Enc(Kcmi:CMi) by means of the content key data Kci, Kcmi, and thereby generates the content data Ci, CMi (step S214). Then, the decoder 244 inputs the content data Ci, CMi into the main control unit 245 (step S215).

Next, the main control unit 245 inputs the content data Ci, CMi into the reproducing unit 24d, and causes the content data Ci, CMi to be reproduced in the reproducing unit 24d at a certain time based on the start time data ST_Time(i) according to the section reproduction condition data URsi. In addition, the main control unit 245 analyzes the next section data PRGSECi in the analysis unit 241 by a certain time based on the end time data END_Time(i). That concludes specific operation of the decoding unit 24c.

[Advantages]

Next, advantages of the content delivery system according to the first embodiment are described. In the first embodiment, the content data Ci, CMi is reproduced according to the reproduction order designated by the reproduction designation data PLi and the condition specified by the reproduction condition data URi. That is, reediting of only the control data Pi (reproduction designation data PLi and reproduction condition data URi) enables decoded content subject to reproduction control to be reedited and the burden on a party who transmits the content data to be reduced. In addition, rewriting the reproduction condition data URi allows a different reproduction condition to be set on a reproduction section basis. Furthermore, the control data Pi (reproduction condition data URi) is transmitted to the user terminal 20 in a state of being encrypted by the user key data Kui, hence security of data is secured.

For example, if the user terminal 20 retains in advance a certain number of the encrypted content data Enc(Kci:Ci), Enc(Kcmi:CMi) and the user key data Kui, then the delivery server 10 simply sequentially transmits different control data Pi to the user terminal 20, thereby the user terminal 20 can reproduce decoded content data whose arrangements and combinations have been changed according to the control data Pi.

### Second Embodiment

[Configuration]

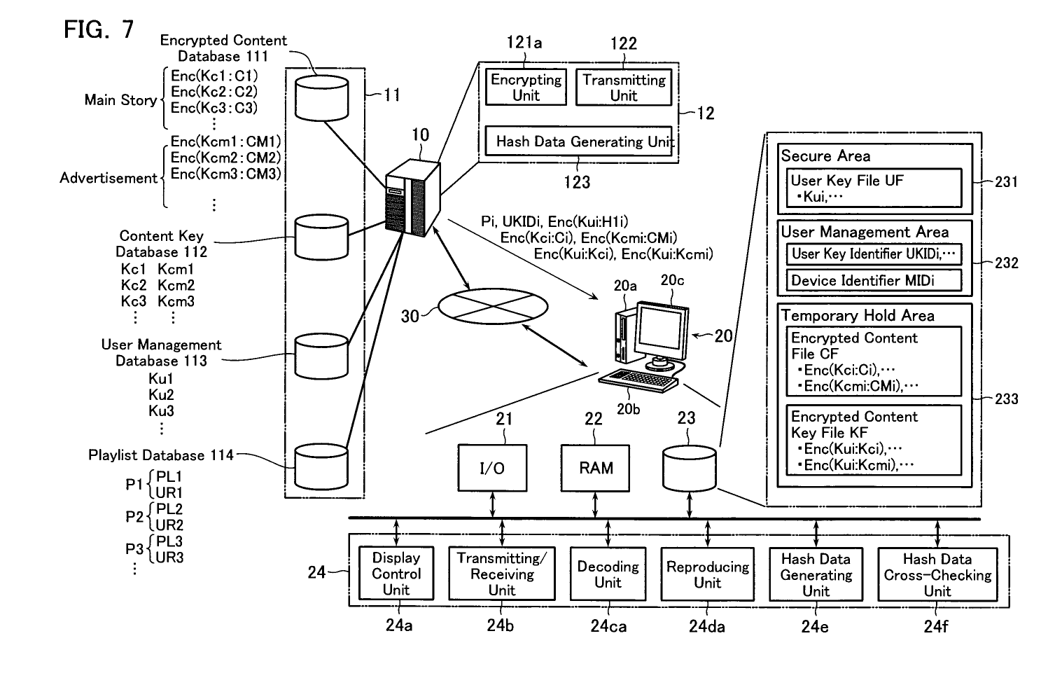

Next, a configuration of a content delivery system according to a second embodiment is described with reference to FIG. 7. In the above-described first embodiment, the control data Pi is encrypted to be delivered as the encrypted control data Enc(Ku:Pi), and is subsequently decoded, thereby guaranteeing security of data. On the other hand, in the second embodiment, the control data Pi is delivered along with an electronic signature, and subsequent cross-checking of the electronic signature allows security of data to be guaranteed. Note that in the second embodiment, similar configurations to those in the first embodiment are assigned with identical symbols, and description of those similar configurations is omitted.

As shown in FIG. 7, the control unit 12 in the delivery server 10 of the second embodiment includes an encrypting unit 121a differing in function from that of the first embodiment, and further includes a hash data generating unit 123. The hash data generating unit 123 performs hash processing of the control data Pi to generate hash data H1i. The encrypting unit 121a encrypts the hash data H1i by means of the user key data Kui, and thereby generates signature data Enc(Kui:H1i). Note that the control data Pi and the signature data Enc(Kui:H1i) are transmitted to the user terminal 20 by the transmitting unit 122.

In addition, as shown in FIG. 7, the control unit 24 in the user terminal of the second embodiment includes a decoding unit 24ca and a reproducing unit 24da differing in function from those of the first embodiment, and further includes a hash data generating unit 24e and a hash data cross-checking unit 24f. The decoding unit 24ca decodes the signature data Enc(Kui:H1i) by means of the user key data Kui, and thereby generates the hash data H1i. The hash data generating unit 24e performs hash processing of the control data Pi, and thereby generates hash data H2i. Now, if the control data Pi has been tampered with, the hash data H2i will be different data to the hash data H1i. The hash data cross-checking unit 24f cross-checks the hash data H1i and the hash data H2i to confirm that the control data Pi has not been tampered with. The reproducing unit 24da shifts to a reproduction operation when it is confirmed by the hash data cross-checking unit 24f that the hash data H1i and the hash data H2i match.

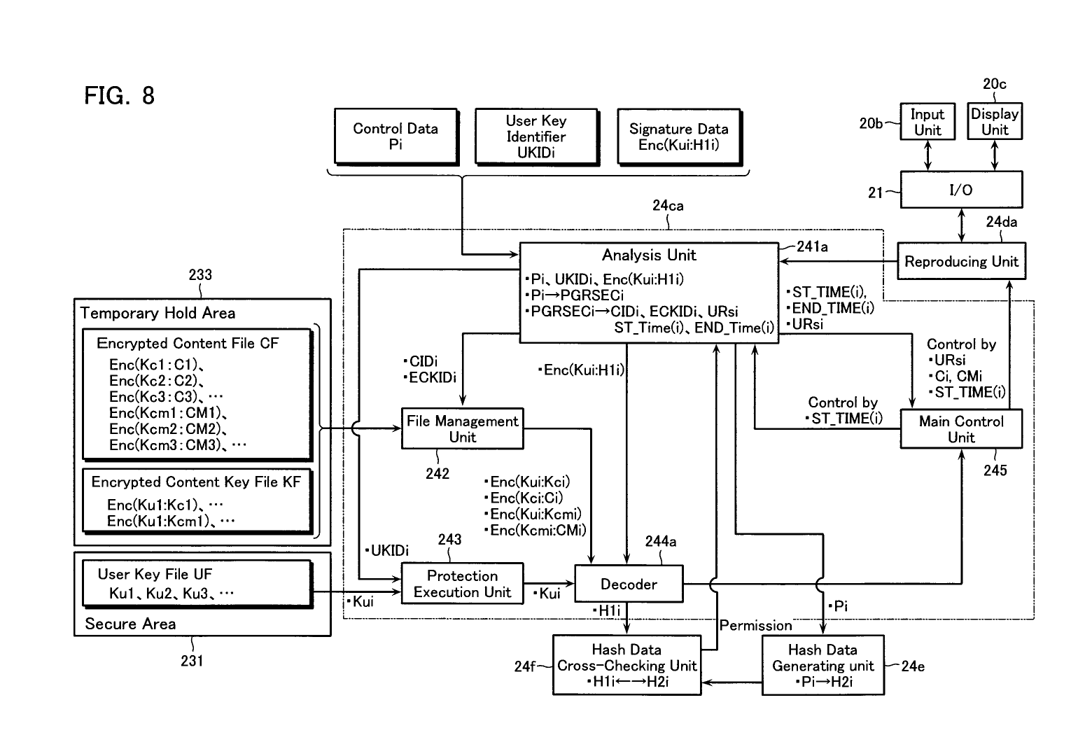

Next, a specific configuration of the decoding unit 24ca in the user terminal 20 is described with reference to FIG. 8. As shown in FIG. 8, the decoding unit 24ca includes an analysis unit 241a and a decoder 244a that differ from those of the first embodiment. The file management unit 242, the protection execution unit 243, and the main control unit 245 execute similar operations to those of the first embodiment.

The analysis unit 241a extracts the control data Pi, the user key identifier UKIDi, and the signature data Enc(Kui:H1i) from the data received by the transmitting/receiving unit 24b. The analysis unit 241a inputs the control data Pi into the hash data generating unit 24e, and inputs the signature data Enc(Kui:H1i) into the decoder 244a. The analysis unit 241a extracts the section data PGRSECi from the control data Pi based on a judgment result by the hash data cross-checking unit 24f.

The decoder 244a decodes the signature data Enc(Kui:H1i) by means of the user key data Kui, thereby generates the hash data H1i, and inputs that hash data H1i into the hash data cross-checking unit 24f.

[Operation]

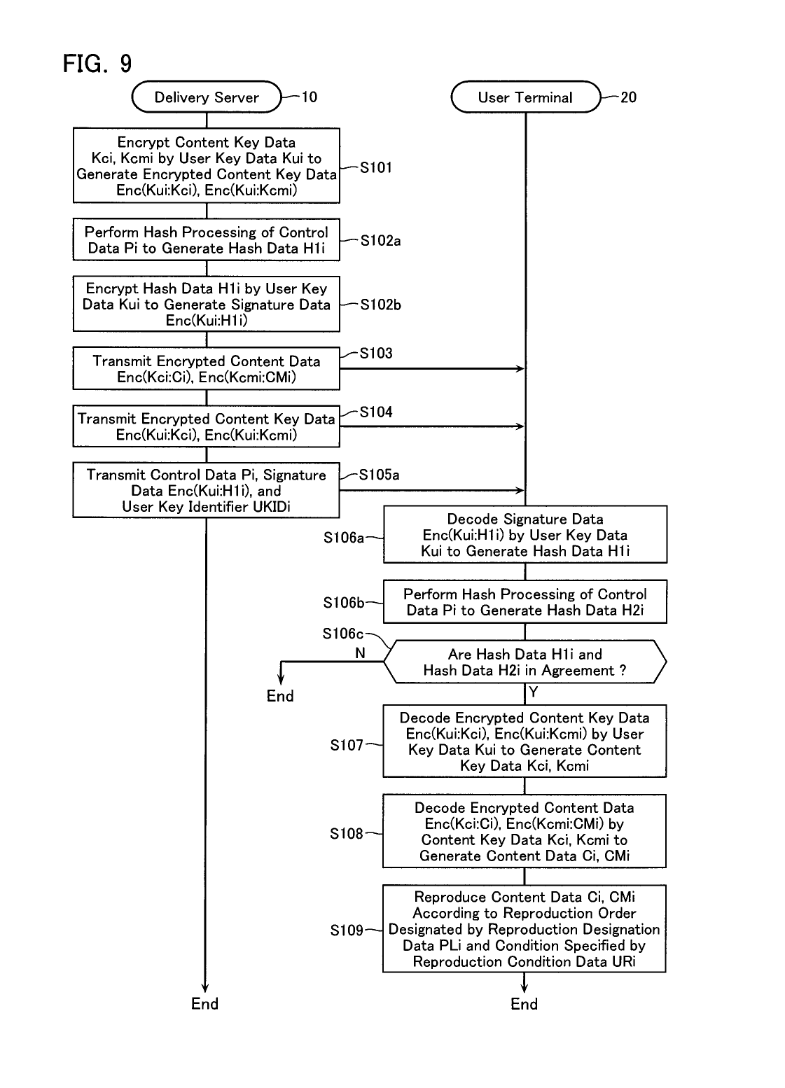

Next, an overview of operation of the content delivery system according to the second embodiment is described with reference to FIG. 9. First, the delivery server 10 executes the step S101 similar to in the first embodiment. Next, the delivery server 10 performs hash processing of the control data Pi in the hash data generating unit 123, and thereby generates the hash data H1i (step S102a). Then, the delivery server 10 encrypts the hash data H1i in the encrypting unit 121a by means of the user key data Kui, and thereby generates the signature data Enc(Kui:H1i) (step S102b). Next, the delivery server 10 executes the steps S103 and S104 similar to in the first embodiment. Then, the delivery server 10 transmits the control data Pi, the hash data H1i, and the user key identifier UKIDi to the user terminal 20 by the transmitting unit 122 (step S105a).

Then, the user terminal 20 decodes the signature data Enc(Kui:H1i) in the decoding unit 24ca by means of the user key data Kui, and thereby generates the hash data H1i (step S106a). Next, the user terminal 20 performs hash processing of the control data Pi in the hash data generating unit 24e, and thereby generates the hash data H2i (step S106b). Then, the user terminal 20 judges in the hash data cross-checking unit 24f whether the hash data H1i and the hash data H2i match (step S106c). In step S106c, if the hash data H1i and the hash data H2i does not match, the user terminal 20 ends the operation (step S106c, N); on the other hand, if the hash data H1i and the hash data H2i match, the user terminal 20 executes the steps S107-S109 similar to in the first embodiment (step S106c, Y). That concludes operation of the content delivery system according to the second embodiment.

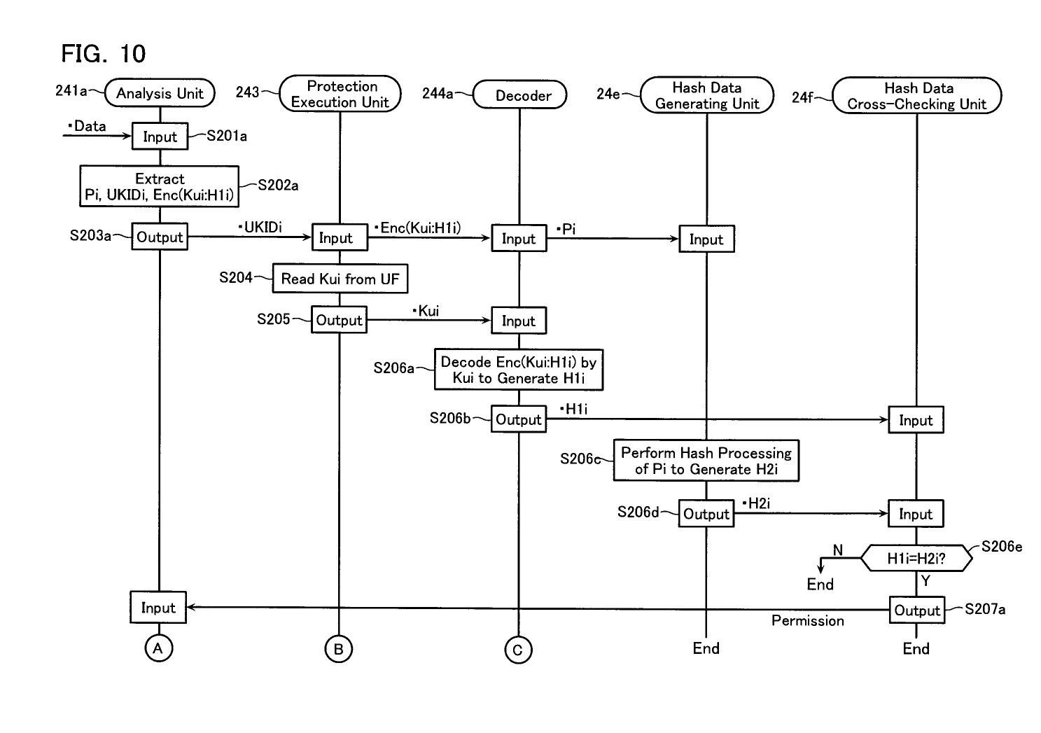

Next, specific operation of the decoding unit 24ca (analysis unit 241a, protection execution unit 243, and decoder 244a), the hash data generating unit 24e, and the hash data cross-checking unit 24f in the user terminal 20 is described with reference to FIG. 10.

As shown in FIG. 10, the analysis unit 241a receives data from the transmitting/receiving unit 24b (step S201a), and extracts from that data the user key identifier UKIDi, the control data Pi, and the signature data Enc(Kui:H1i) (step S202a). Then, the analysis unit 241a inputs the user key identifier UKIDi into the protection execution unit 243, while inputting the signature data Enc(Kui:H1i) into the decoder 244a and further inputting the control data Pi into the hash data generating unit 24e (step S203a).

Next, the protection execution unit 243 executes the steps S204 and S205 similar to in the first embodiment. Then, the decoder 244a decodes the signature data Enc(Kui:H1i) by means of the read user key data Kui, and thereby generates the hash data H1i (step S206a). Next, the decoder 244a inputs the hash data H1i into the hash data cross-checking unit 24f (step S206b).

Then, the hash data generating unit 24e performs hash processing of the control data Pi, thereby generates the hash data H2i (step S206c), and inputs the hash data H2i into the hash data cross-checking unit 24f (step S206d). Next, the hash data cross-checking unit 24f judges whether the hash data H1i and the hash data H2i match (step S206e). Next, if the hash data H1 i and the hash data H2i match, the hash data cross-checking unit 24f inputs a control signal into the analysis unit 241a to permit subsequent processing in the analysis unit 241a (step S207a). After step S207a, the steps S208-S216 similar to in the first embodiment are executed.

[Advantages]

The second embodiment displays similar advantages to the first embodiment. In addition, the second embodiment secures security of data by cross-check processing based on the signature data Enc(Kui:H1i). Accordingly, there is no need to encrypt the control data Pi itself, hence the second embodiment allows time required for decoding to be reduced more than in the first embodiment.

### Third Embodiment

[Configuration of Control Data Pi]

Next, a configuration of control data Pi in a content delivery system according to a third embodiment is described. In the third embodiment, only the configuration of the control data Pi differs from that of the first embodiment, and other configurations are similar to those of the first embodiment. Note that in the third embodiment, a description of configurations similar to those in the first and second embodiments is omitted.

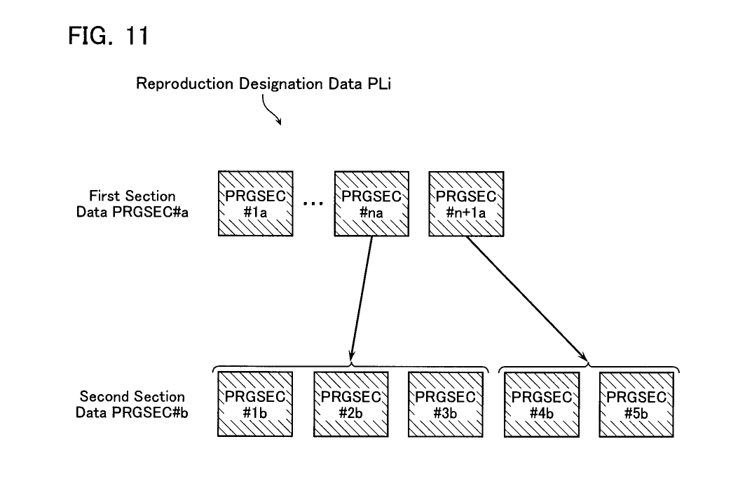

As shown in FIG. 11, in the third embodiment, the reproduction designation data PLi has a hierarchical structure of first section data PRGSEC#a (PRGSEC#1a, . . . , PRGSEC#na, PRGSEC#n+1a) and second section data PRGSEC#b (PRGSEC#1b, PRGSEC#2b, . . . , PRGSEC#5b). Second section data PLGSEC#1b-#5b (PLGSEC#b) each designates one content data Ci, CMi.

One first section data PLGSEC#a designates a plurality of second section data PLGSEC#1b-#5b. FIG. 11 shows an example where one first section data PLGSEC#na designates three second section data PLGSEC#1b-#3b, and one first section data PLGSEC#n+1a designates two second section data PLGSEC#4b, 5b. Note that one first section data PLGSEC#a may be data designating one second section data PLGSEC#b.

[Advantages]

In the content delivery system according to the third embodiment, the reproduction designation data PLi includes first section data PLGSEC#a and second section data PLGSEC#b. This enables the reproduction order of the content data Ci, CMi to be easily changed.

### Fourth Embodiment

[Method of Using Reproduction Condition Data URi]

Next, a method of using reproduction condition data URi in a content delivery system according to a fourth embodiment is described. In the fourth embodiment, only the method of using the reproduction condition data URi differs from that of the first embodiment, and other configurations are similar to those of the first embodiment. Note that in the fourth embodiment, a description of configurations similar to those in the first through third embodiments is omitted.

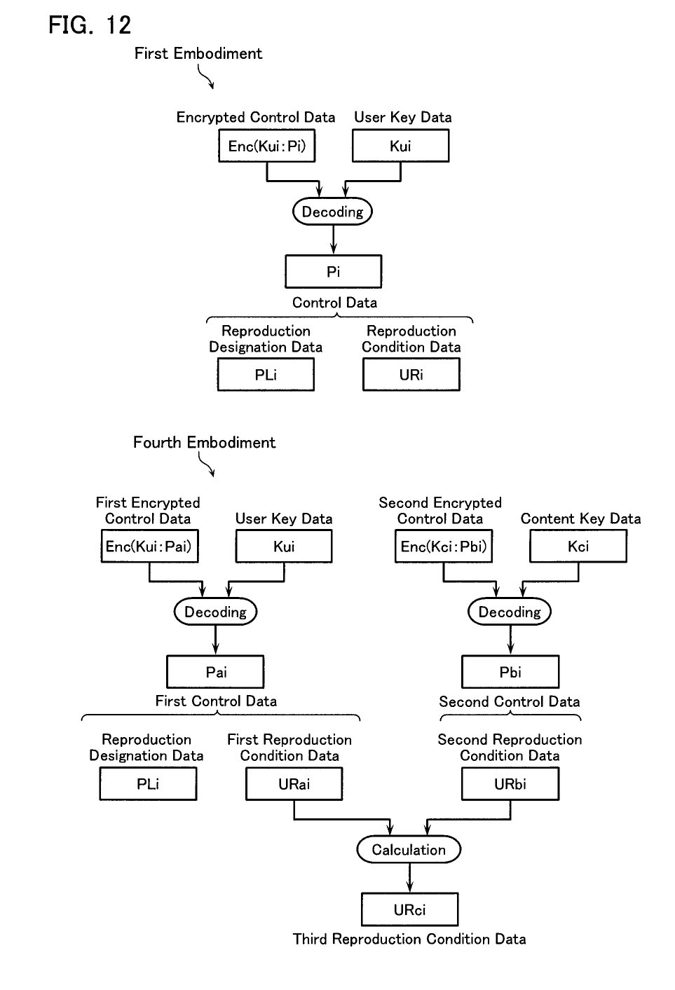

As shown in FIG. 12, in the above-mentioned first embodiment, the user terminal 20 decodes the encrypted control data Enc(Kui:Pi) by means of the user key data Kui, and thereby generates the control data Pi. Then, the user terminal 20 uses the reproduction condition data URi and the reproduction designation data PLi included in this control data Pi to reproduce the content data Ci, CMi.

In contrast, in the fourth embodiment, the delivery server 10 generates first encrypted control data Enc(Kui:Pai) that has control data Pai encrypted by means of the user key data Kui, and provides this first encrypted control data Enc(Kui:Pai) to the user terminal 20. As shown in FIG. 12, the user terminal 20 decodes the first encrypted control data Enc(Kui:Pai) by means of the user key data Kui, and thereby generates first control data Pai.

In addition to this, the delivery server 10 generates second encrypted control data Enc(Kci:Pbi) that has control data Pbi encrypted by means of the content key data Kci, and provides this second encrypted control data Enc(Kci:Pbi) to the user terminal 20. The user terminal 20 decodes the second encrypted control data Enc(Kci:Pbi) by means of the content key data Kci, and thereby generates second control data Pbi.

Next, the user terminal 20 extracts first reproduction condition data URai and the reproduction designation data PLi from the first control data Pai. In addition, the user terminal 20 extracts second reproduction condition data URbi from the second control data Pbi. Then, a calculation having these two kinds of reproduction condition data URai and URbi as input values is performed to generate third reproduction condition data URci. That is, in this fourth embodiment, the content data Ci, CMi only becomes reproducible at a point in time when both the first reproduction condition data URai and the second reproduction condition data URbi have been provided to the user terminal 20.

The user terminal 20 uses this third reproduction condition data URci and the reproduction designation data PLi, and thereby generates the content data Ci, CMi.

[Advantages]

The content delivery system according to the fourth embodiment can only generate the third reproduction condition data URci at a point in time when the user key data Kui and the content key data Kci have both been provided. Therefore, security of data in the fourth embodiment is raised more than in the first through third embodiments.

### Other Embodiments

That concludes description of embodiments of the content delivery system according to the present invention, but it should be noted that the present invention is not limited to the above-described embodiments, and that various alterations, additions, substitutions, and so on, are possible within a range not departing from the scope and spirit of the invention.

For example, when permission is granted for reproduction in accordance with a certain reproduction procedure by the reproduction condition data URi, the content data Ci, CMi may be reproduced by either of the two kinds of methods indicated below. In the first method, data to be permitted to be reproduced is retained in the memory unit 23 of the user terminal 20, and the reproducing unit 24d reproduces the content data Ci, CMi, referring to that data to be permitted to be reproduced, based on the reproduction condition data URi. In the second method, the reproduction condition data URi itself is rewritten, and the reproducing unit 24d reproduces content data C based on that rewritten reproduction condition data URi.

For example, FIGS. 1 and 7 describe a configuration where one each of the delivery server 10 and the user terminal 20 are disposed, but the present invention is not limited to this configuration. A configuration may be adopted having a plurality of the delivery servers 10 provided, each of the delivery servers 10 including one each of the databases 111-114. Moreover, the user terminal 20 may be a mobile phone or the like rather than a personal computer, and is not limited to being personally owned by the user, but may be a terminal for shared use among the public disposed in the likes of an internet cafe, a convenience store, or a gasoline stand.

### DESCRIPTION OF REFERENCE NUMERALS

10 delivery server
11 memory unit
111 encrypted content database
112 content key database
113 user management database
114 playlist database
12 control unit
121 encrypting unit
122 transmitting unit
20 user terminal
20a user terminal main body
20b input unit
20c display unit
21 I/O
22 RAM
23 memory unit
24 control unit
24a display control unit
24b transmitting/receiving unit
24c decoding unit
24d reproducing unit

1. A content delivery system comprising a user terminal maintained by a user, and a delivery server for delivering content data to the user terminal,
the delivery server comprising:
a transmitting unit configured to transmit to the user terminal encrypted content data encrypted by content key data that differs on a content data basis, transmit to the user terminal encrypted content key data that is the content key data encrypted by user key data that differs on a user basis, and transmit to the user terminal encrypted control data that is control data for controlling a reproduction operation of the content data encrypted by the user key data,
the control data including:
reproduction designation data that designates a reproduction order of the content data to be reproduced; and reproduction condition data that specifies a condition for permitting reproduction of the content data, and
the user terminal comprising:
a decoding unit configured to generate the content key data based on the encrypted content key data and the user key data, generate the control data based on the encrypted control data and the user key data, and generate the content data based on the content key data and the encrypted content data; and
a reproducing unit configured to reproduce the content data according to the reproduction order designated by the reproduction designation data and the condition specified by the reproduction condition data.

2. A content delivery system including a user terminal maintained by a user, and a delivery server for delivering content data to the user terminal, the delivery server comprising:
a first hash data generating unit configured to perform hash processing of control data controlling a reproduction operation of the content data and thereby generate first hash data;
an encrypting unit configured to encrypt the first hash data by user key data that differs on a user basis and thereby generate signature data; and
a transmitting unit configured to transmit to the user terminal encrypted content data encrypted by content key data that differs on a content data basis, transmit to the user terminal encrypted content key data that is the content key data encrypted by the user key data that differs on a user basis, and transmit to the user terminal the control data and the signature data,
the control data including:
reproduction designation data that designates a reproduction order of the content data to be reproduced; and reproduction condition data that specifies a condition for permitting reproduction of the content data, and
the user terminal comprising:
a decoding unit configured to generate the content key data based on the encrypted content key data and the user key data, generate the content data based on the content key data and the encrypted content data, and generate the first hash data based on the user key data and the signature data;
a second hash data generating unit configured to perform hash processing of the control data and thereby generate second hash data;
a hash data cross-checking unit for cross-checking the first hash data and the second hash data; and
a reproducing unit configured to, when it is judged by the hash data cross-checking unit that the first hash data and the second hash data match, reproduce the content data according to the reproduction order designated by the reproduction designation data and the condition specified by the reproduction condition data.

3. The content delivery system according to claim 1 or 2, wherein
the reproduction designation data comprises:
a plurality of first designated data; and
a plurality of second designated data that each designate one content data, and one first designated data designates one or a plurality of the second designated data.

4. A delivery server for delivering content data to a user terminal, comprising:
a transmitting unit configured to transmit to the user terminal encrypted content data encrypted by content key data that differs on a content data basis, transmit to the user terminal encrypted content key data that is the content key data encrypted by user key data that differs on a user basis, and transmit to the user terminal encrypted control data that is control data for controlling a reproduction operation of the content data encrypted by the user key data,
the control data including:
reproduction designation data that designates a reproduction order of the content data to be reproduced; and reproduction condition data that specifies a condition for permitting reproduction of the content data.

5. A user terminal comprising:
a decoding unit configured to generate content key data that differs on a content data basis based on user key data and encrypted content key data that differ on a user basis, generate control data for controlling a reproduction operation of the content data based on encrypted control data and the user key data, and generate the content data based on the content key data and the encrypted content data; and
a reproducing unit for reproducing the content data based on the control data,
the control data including:
reproduction designation data that designates a reproduction order of the content data to be reproduced; and reproduction condition data that specifies a condition for permitting reproduction of the content data, and
the reproducing unit reproducing the content data according to the reproduction order designated by the reproduction designation data and the condition specified by the reproduction condition data.
